(19) United States
(12) Patent Application Publication
(10) Pub. No.: US 2007/0282878 A1
(43) Pub. Date: Dec. 6, 2007

(54) System and method for online reorganization of a database using flash image copies

(75) Inventor: Brian J. Marshall, Napa, CA (US)

Correspondence Address: BAKER BOTTS L.L.P., 2001 ROSS AVENUE, SUITE 600, DALLAS, TX, 75201-2980, US

(73) Assignee: COMPUTER ASSOCIATES THINK INC.

(21) Appl. No.: 11/444,030

(22) Filed: May 30, 2006

(51) Int. Cl. G06F 7/00

(52) U.S. Cl. 707/101

(57) ABSTRACT

A method for reorganizing a database comprises receiving at least one update to a first database. The method continues by generating a copy of the first database. The method continues by generating a shadow database, wherein the shadow database represents a reorganized version of the first database and is based at least in part on the copy of the first database. The method continues by applying the at least one update to the shadow database. The method concludes by replacing the first database with the shadow database.

### TECHNICAL FIELD OF THE INVENTION

This invention relates generally to electronic databases and more specifically to a system and method for online reorganization of a database using flash image copies.

### BACKGROUND OF THE INVENTION

Database systems are widely used for storing, managing, organizing and processing data. In a database, records may be linked in a tree-like logical structure. When a transaction is performed such that data is added, updated, and/or deleted from the database, the data may become disorganized or fragmented. When data becomes disorganized or fragmented, response time to database queries may increase. As a result, it may be desirable to occasionally reorganize a database to make the database system more efficient.

Traditionally, reorganizing a database involves taking the database offline. When a database is offline, clients are unable to access and use the database. Because many databases need to be accessible all or nearly all of the time, the offline time associated with database reorganization may be undesirable.

To reduce offline time associated with database reorganization, attempts have been made to reorganize a database while the database remains online. However, when a database remains online, the database may receive updates during the reorganization procedure. Updates received during online reorganization have traditionally been considered problematic. Before applying the update to a particular database being reorganized, the database system must determine whether the corresponding data record in that database has already been reorganized. To make this determination, the database system tracks the timestamp associated with the update and the timestamps associated with each phase of the reorganization process. This procedure for handling updates during online reorganization consumes time and computing resources.

### SUMMARY OF THE INVENTION

In accordance with the present invention, the disadvantages and problems associated with traditional reorganization of a database have been substantially reduced or eliminated.

A method for reorganizing a database comprises receiving at least one update to a first database. The method continues by generating a copy of the first database. The method continues by generating a shadow database, wherein the shadow database represents a reorganized version of the first database and is based at least in part on the copy of the first database. The method continues by applying the at least one update to the shadow database. The method concludes by replacing the first database with the shadow database.

The invention has several important technical advantages. Various embodiments of the invention may have none, some, or all of these disadvantages. One advantage of the present invention is that it reduces the amount of time that a database is offline during reorganization of the database. Another advantage is that the present invention eliminates the need to compare timestamps associated with particular updates with timestamps associated with the reorganization of corresponding data records in a database.

Other advantages will be readily apparent to one having ordinary skill in the art from the following figures, descriptions, and claims.

### BRIEF DESCRIPTION OF THE DRAWINGS

For a more complete understanding of the present invention and for further features and advantages, reference is now made to the following description taken in conjunction with the accompanying drawings in which:

FIG. 1 illustrates a database system according to certain embodiments of the present invention;

FIG. 2 illustrates a flow of operation among various components of the database system illustrated in FIG. 1 according to certain embodiments of the present invention;

FIG. 3 illustrates a flowchart for online reorganization of a database according to certain embodiments of the present invention; and

FIG. 4 illustrates a flowchart for intercepting updates to a database according to certain embodiments of the present invention.

### DETAILED DESCRIPTION OF THE DRAWINGS

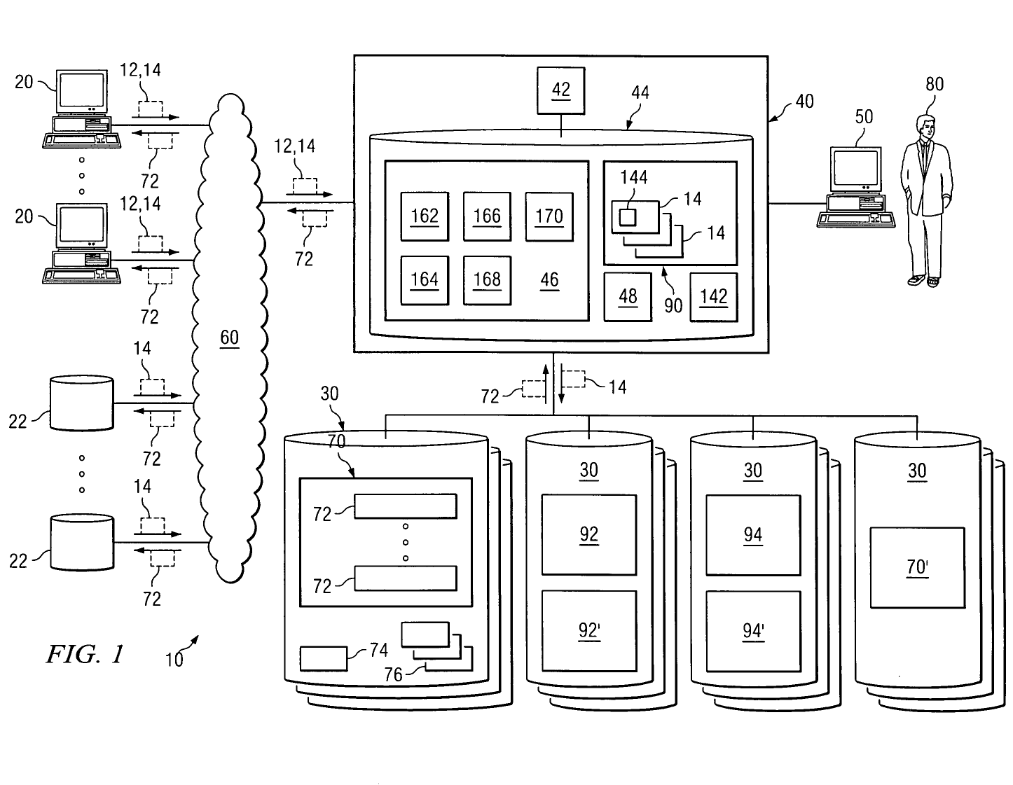

FIG. 1 illustrates one embodiment of a database system 10. Generally database system 10 is operable to process queries 12 for data stored in one or more databases 70. Database system 10 is further operable to reorganize a particular database 70 while that database 70 remains accessible for responding to queries 12. Database system 10 may generally comprise a plurality of clients 20 and/or data sources 22, one or more memory modules 30, a manager server 40, and an operator console 50 communicatively coupled by one or more networks 60.

Database system 10 generally comprises one or more databases 70. Database 70 is a matrix, table, compilation, and/or grouping of data records 72. A data record 72 may comprise one or more fields of data. In database 70, data records 72 may be organized and/or linked in any suitable fashion. For example, in a hierarchical database 70, data records 72 may be linked in a tree-like logical structure. Database 70 may represent an IMS database, an online analytical processing database, an online transaction processing database, a flat-file database, a network database, a relational database, an object-oriented database, and/or any other suitable number and combination of databases. Database system 10 is operable to apply updates 14 to databases 70 and to receive and respond to queries 12 from clients 20.

Database 70 may be associated with a primary index 74. Primary index 74 facilitates the location, sorting, referencing, and/or retrieval of data in database 70. The primary index 74 may be based on a particular field of data record 72. Database 70 may also be associated with one or more secondary indexes 76. Secondary index 76 may facilitate the location and/or retrieval of data to satisfy queries 12 that are not based on the particular field associated with the primary index 74. For example, a particular database 70 of employee information may have primary index 74 based on social security number. However, to facilitate queries 12 based on the surname of an employee, that database 70 may also be associated with secondary index 76 based on surname.

Query 12 refers to a request for particular data stored in databases 70. Query 12 may be based on any field or combination of fields associated with data in databases 70. Query 12 may consist of one or more search terms coupled by any suitable number and combination of logical connectors. Update 14 refers to a change to, addition to, deletion of, and/or modification of data in database 70. Update 14 may be submitted to database 70 from data source 22, client 20, operator console 50, and/or any other suitable node external and/or internal to database system 10.

Client 20 is communicatively coupled to manager server 40 via network 60. Client 20 is operable to transmit queries 12 and/or updates 14 to manager server 40. Client 20 may represent any suitable device for transmitting and/or receiving electronic communications. Client 20 may represent a computer, work station, electronic notebook, mobile phone, handheld device, personal data assistant (PDA), pager, mini computer, or other device capable of wireless and/or wireline communications. It will be understood that there may be any number and combination of clients 20 in database system 10.

Data source 22 is communicatively coupled to manager server 40 via network 60. Data source 22 represents a data feed, memory, data network, and/or any other suitable number and combination of informational sources. Data source 22 is operable to transmit to manager server 40 updates 14 related to databases 70 in memory modules 30. Data source 22 may represent a computer, work station, electronic notebook, mobile phone, handheld device, personal data assistant (PDA), pager, mini computer, or other device capable of wireless and/or wireline communications. It will be understood that there may be any number and combination of data sources 22 in database system 10.

Database system 10 comprises manager server 40. Manager server 40 is generally operable to manage and maintain one or more databases 70 in memory modules 30. In particular, manager server 40 is operable to receive queries 12 from clients 20 and to determine the data in database 70 that satisfies queries 12. Manager server 40 is further operable to receive updates 14 to databases 70 from clients 20 and/or data sources 22 and to change the databases 70 according to the updates 14.

During the course of normal use, database 70 may become disorganized. As a result, database 70 may need to be reorganized to become more efficient. Reorganization refers to the process of restructuring, reorganizing, and/or rebuilding a database 70 to improve the speed and/or efficiency of a database system 10. Reorganization of database 70 may comprise unloading the database 70 (i.e., removing data), clustering data, ordering data, inserting data, deleting data, and/or reloading the database 70. Manager server 40 is operable to reorganize databases 70 by generating flash image copies 92 of databases 70. Using flash image copy 92 of a particular database 70, manager server 40 may generate and organize a shadow database 70′ that represents a reorganized version of the original database 70. By using flash image copy 92 to generate shadow database 70′, manager server 40 is operable to eliminate or reduce the amount of time that database 70 is offline during reorganization. Reducing offline time is especially desirable for databases 70 that are used by clients 20 substantially all the time.

Manager server 40 may comprise a general-purpose personal computer (PC), a Macintosh, a workstation, a Unix-based computer, a server computer, or any suitable processing device. Manager server 40 may include any hardware, software, firmware, or combination thereof operable to perform the above operations and functions. To make system 10 more robust, manager server 40 may be associated with a redundant manager server 40 which is operable to assume substantially all of the functionality of manager server 40 in the event of a failure. Although FIG. 1 provides one example of manager server 40 that may be used with the invention, system 10 can be implemented using computers other than servers, as well as a server pool.

Manager server 40 comprises a manager memory 44 and a processor 42. Manager memory 44 comprises logic 46 that, when executed, is operable to manage databases 70, process queries 12, apply updates 14 to databases 70, and reorganize databases 70. Manager memory 44 is communicatively coupled to processor 42. Processor 42 is operable to execute logic 46 to perform the described functions and operations.

Logic 46 in manager memory 44 comprises instructions for reorganizing databases 70. Logic 46 may comprise a plurality of modules for managing the reorganization process. In particular, logic 46 may comprise a call intercept module 162, call replay module 164, secondary index builder module 166, database image copier module 168, and database organizer module 170. By executing the modules in logic 46, processor 42 is operable to reorganize database 70 while reducing the offline time associated with the reorganization.

Manager server 40 may be communicatively coupled to a plurality of memory modules 30. Memory modules 30 are generally operable to store databases 70 and other information associated with database system 10. Memory module 30 may represent any memory device, direct access storage device (DASD), or database module and may take the form of volatile or non-volatile memory comprising, without limitation, magnetic media, optical media, random access memory (RAM), read-only memory (ROM), removable media, or any other suitable local or remote memory component. Memory module 30 may store databases 70, indexes associated with databases 70, shadow databases 70′, flash image copies 92, and physical image copies 94 of databases 70. It will be understood that there may be any suitable number and combination of memory modules 30 communicatively coupled to manager server 40.

Manager server 40 may be communicatively coupled to operator console 50. Operator console 50 may represent any suitable device for transmitting and/or receiving electronic communications. Operator console 50 may represent a computer, work station, electronic notebook, mobile phone, handheld device, personal data assistant (PDA), pager, mini computer, or other device capable of wireless and/or wireline communications. It will be understood that there may be any number and combination of operator consoles 50 in database system 10.

Operator 80 may be a person, computer, machine, and/or any other suitable entity that monitors, controls, and/or maintains database system 10. According to certain embodiments, operator 80 may be a system administrator associated with database system 10. It will be understood that there may be any number and combination of operators 80 associated with database system 10.

Clients 20, data sources 22, manager server 40, memory modules 30, and operator console 50 may be communicatively coupled via one or more networks 60. Network 60 may represent any number and combination of wireline and/or wireless networks suitable for data transmission. Network 60 may, for example, communicate internet protocol packets, frame relay frames, asynchronous transfer mode cells, and/or other suitable information between network addresses. Network 60 may include one or more intranets, local area networks, metropolitan area networks, wide area networks, cellular networks, all or a portion of the Internet, and/or any other communication system or systems at one or more locations.

In operation, database system 10 is operable to reorganize a particular database 70 while that database 70 remains online and accessible for responding to queries 12 from clients 20. In particular, processor 42 may receive a command to reorganize a particular database 70. In response, processor 42 may temporarily take the particular database 70 offline. Processor 42 may then use memory module 30 to generate a flash image copy 92 of the particular database 70. Flash image copy 92 represents a replica of the particular database 70. According to certain embodiments, processor 42 generates flash image copy 92 of the particular database 70 by copying that database 70 byte by byte. Processor 42 may store flash image copy 92 of the particular database 70 in the same memory module 30 as the original database 70. In other embodiments, flash image copy 92 may be stored in one or more different memory modules 30.

When processor 42 receives the command to reorganize database 70, processor 42 may begin to intercept updates 14 to the particular database 70 from clients 20 and/or data sources 22. Processor 42 may store the intercepted updates 14 in manager memory 44 and/or any number and combination of memory modules 30. According to certain embodiments, the portion of manager memory 44 and/or memory module(s) 30 used for storing intercepted updates 14 is referred to as “call intercept memory” 90.

Once flash image copy 92 of the particular database 70 is complete, processor 42 may place the particular database 70 back online. When database 70 is online, database 70 is available for responding to queries 12 submitted by clients 20.

After processor 42 generates flash image copy 92 of database 70, processor 42 may use flash image copy 92 to generate physical image copy 94 of database 70. Physical image copy 94 refers to a physical copy of database 70. In some embodiments, blocks of database 70 may be arranged sequentially in physical image copy 94. In physical image copy 94, each block of database 70 may be associated with a header segment. Processor 42 may store physical image copy 94 in any number and combination of memory modules 30 communicatively coupled to manager server 40.

Once physical image copy 94 of the particular database 70 is complete, processor 42 may use flash image copy 92 and/or physical image copy 94 to generate shadow database 70′ of the particular database 70. To generate shadow database 70′, processor 42 may copy and/or reorganize the data in flash image copy 92 and/or physical image copy 94. In particular, processor 42 may reorganize data records 72 from flash image copy 92 and/or physical image copy 94 to make shadow database 70′ a more efficient and/or organized version of the original database 70. Thus, shadow database 70′ represents a reorganized copy of the original database 70. Processor 42 may store shadow database 70′ in any number and combination of memory modules 30.

After generating shadow database 70′, processor 42 may determine whether the original database 70 is associated with one or more secondary indexes 76. If processor 42 determines that the original database 70 is associated with one or more secondary indexes 76, processor 42 may reorganize the one or more secondary indexes 76 to correspond to the reorganized structure of shadow database 70′. Processor 42 may store the one or more reorganized secondary indexes 76 in any number and combination of memory modules 30.

Throughout the reorganization process, processor 42 continues to intercept updates 14 to the original database 70 from clients 20 and/or data sources 22. Processor 42 stores the intercepted updates 14 in call intercept memory 90. After generating shadow database 70′, processor 42 may transfer the intercepted updates 14 from call intercept memory 90 to shadow database 70′. The step of transferring the intercepted updates 14 to shadow memory may be referred to as “call replay.” Processor 42 is operable to determine an appropriate location in shadow database 70′ to apply each intercepted update 14. For example, if an intercepted update 14 corresponds to a particular data record 72 in shadow database 70′, processor 42 is operable to identify in shadow database 70′ a space that corresponds to or is near to the particular data record 72. Processor 42 may then apply the intercepted update 14 to the identified space in shadow database 70′.

After replaying intercepted updates 14 to shadow database 70′, processor 42 may take the original database 70 offline. Subsequently, processor 42 may initiate a second call replay. In particular, processor 42 may replay to shadow database 70′ all updates 14 in call intercept memory 90 that processor 42 intercepted since the first call replay. This second call replay may help ensure that all updates 14 received since the beginning of the reorganization process are applied to shadow database 70′.

After the second call replay, processor 42 may register shadow database 70′ with manager memory 44 in manager server 40. Some database systems 10 may require that the reorganized database 70 have the same name as the original database 70. Accordingly, processor 42 may swap the naming convention of the original database 70 with that of shadow database 70′. By registering shadow database 70′ with manager memory 44 in manager server 40, processor 42 may activate shadow database 70′ in place of the original database 70.

After the second call replay, processor 42 may use memory module 30 to create flash image copy 92′ of shadow database 70′. (Flash image copy 92′ of shadow database 70′ is designated in FIG. 1 as 92′.) Processor 42 may store flash image copy 92′ of shadow database 70′ in any number and combination of memory modules 30. Database system 10 may use flash image copy 92′ of shadow database 70′ to recover or repair shadow database 70′ in the event shadow database 70′ becomes damaged.

After registering shadow database 70′ with manager memory 44, processor 42 may place shadow database 70′ online. Shadow database 70′ represents a reorganized version of the original database 70. Furthermore, shadow database 70′ comprises the updates 14 from clients 20 submitted during the reorganization process. Because shadow database 70′ is a reorganized version of the original database 70, shadow database 70′ may enable database system 10 to more quickly and efficiently process queries 12 from clients 20.

After shadow database 70′ is placed back online, processor 42 may use flash image copy 92′ of shadow database 70′ to generate physical image copy 94′ of shadow database 70′. (Physical image copy 94′ of shadow database 70′ is designated in FIG. 1 as 94′.) Physical image copy 94′ of shadow database 70′ may be registered with manager memory 44 for recovery purposes. If database system 10 is operable to use flash image copy 92′ of shadow database 70′ for recovery purposes, it may not be necessary to create physical image copy 94′ of shadow database 70′.

According to certain embodiments, manager memory 44 may comprise database recovery control (DBRC) module 48. DBRC module 48 comprises logic or instructions for recovering and/or repairing a particular database 70 if that database 70 is damaged, deleted, destroyed, or otherwise modified. Upon executing DBRC module 48, processor 42 may use flash image copy 92′ and/or physical image copy 94′ to recover shadow database 70′ if shadow database 70′ become damaged. Although DBRC module 48 is illustrated as residing in manager memory 44, it should be understood that DBRC module 48 may, additionally or alternatively, reside in any number and combination of memory modules 30.

As described above, database system 10 is operable to reorganize a particular database 70 using flash image copy 92 of that database 70. Moreover, database system 10 is operable to intercept from clients 20 updates 14 to the database 70 during the reorganization of database 70. By replaying the intercepted updates 14 to shadow database 70′, database system 10 may ensure that shadow database 70′ comprises updates 14 submitted during the reorganization process. Database system 10 simplifies the reorganization of a particular database 70 by intercepting updates 14 as soon as the reorganization process begins. Determining which updates 14 to apply to shadow database 70′ is simplified because database system 10 may apply all intercepted updates 14 that correspond to the particular database 70. Manager server 40 is not required to track timestamps associated with individual updates 14 to determine, on an update-by-update basis, whether to apply a particular update 14 to the reorganized shadow database 70′. Thus, database system 10 may conserve processing time and resources by simplifying the determination of which updates 14 to apply to shadow database 70′.

At a given time, manager server 40 may receive from clients 20 updates 14 for multiple different databases 70 in memory modules 30. Manager server 40 is operable to determine which updates 14 correspond to which databases 70. Moreover, manager server 40 is operable to determine whether a particular update 14 corresponds to a particular database 70 that is currently being reorganized. Manager server 40 is operable to reorganize multiple databases 70 simultaneously and to maintain in manager memory 44 a list 142 of databases 70 currently being reorganized. Upon receiving a particular update 14, processor 42 may scan the update 14 to determine the database definition (DBD) 144 associated with that update 14. Processor 42 may then compare DBD 144 associated with that update 14 against the list 142 of databases 70 currently being reorganized. If processor 42 determines that DBD 144 associated with the particular update 14 matches a particular database 70 in the list 142 of databases 70 currently being reorganized, processor 42 may intercept and store that update 14 in call intercept memory 90. If processor 42 determines that DBD 144 associated with the particular update 14 does not match a particular database 70 in the list 142 of databases 70 currently being reorganized, then that update 14 may be applied to the appropriate database 70 in memory module 30. The intercepted updates 14 in call intercept memory 90 may be partitioned and/or organized according to the particular databases 70 to which the intercepted updates 14 apply. Thus, processor 42 may identify and replay to a particular database 70 those intercepted updates 14 that apply to that database 70. Because the intercepted updates 14 are partitioned according to the corresponding databases 70, processor 42 may avoid replaying to a particular database 70 intercepted updates 14 that do not apply to that database 70.

Logic 46 in manager memory 44 comprises instructions that, when executed, may direct processor 42 in manager server 40 to reorganize a particular database 70 using flash image copy 92 of that database 70. In some embodiments, logic 46 may comprise multiple logic modules, wherein each logic module applies to a particular aspect of the reorganization process. In particular, logic 46 may comprise a call intercept module 162, call replay module 164, secondary index builder module 166, database image copier module 168, and database organizer module 170. By executing the modules in logic 46, processor 42 is operable to reorganize database 70 while reducing the offline time associated with the reorganization.

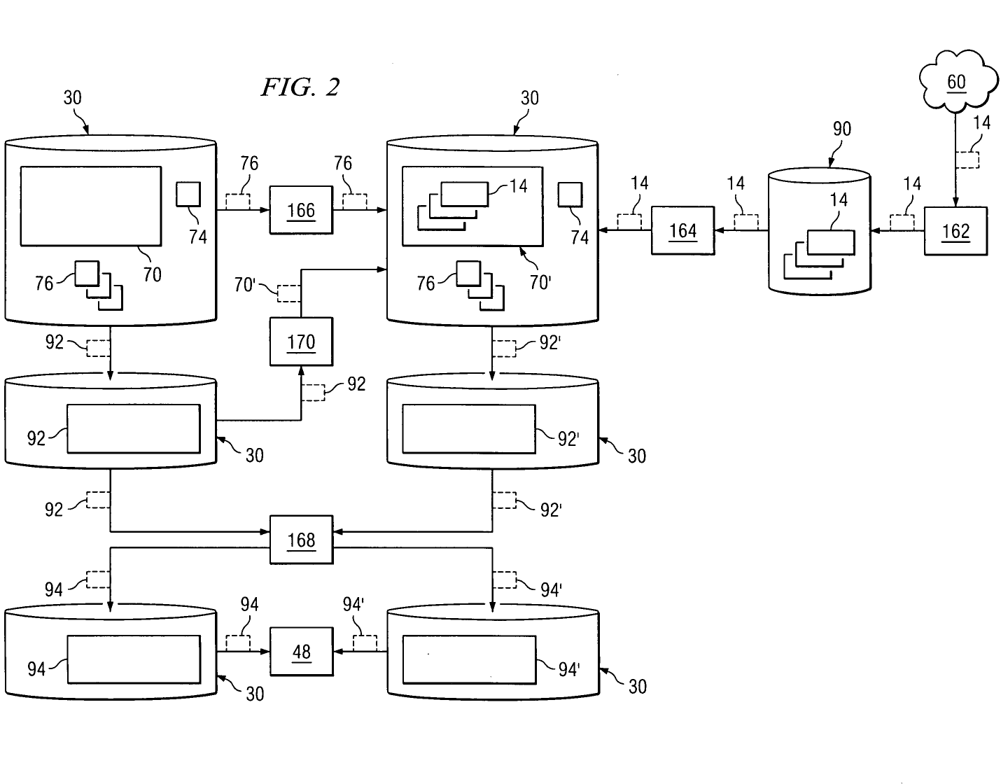

FIG. 2 illustrates a flow of operation among the logic modules associated with logic 46. When manager server 40 receives a command to reorganize a particular database 70, call intercept module 162 may begin to intercept updates 14 to the particular database 70 from clients 20 and/or data sources 22. The intercepted updates 14 may be stored in call intercept memory 90. At the start of the reorganization process, processor 42 may take the particular database 70 offline. Processor 42 may use memory module 30 to generate flash image copy 92 of the particular database 70. Processor 42 may then place the particular database 70 back online.

Once flash image copy 92 of the particular database 70 is complete, database image copier module 168 may use flash image copy 92 to generate physical image copy 94 of the particular database 70. Physical image copy 94 of a particular database 70 represents a copy wherein each block of database 70 is associated with a header segment and each block of the database 70 is arranged sequentially. Physical image copy 94 may be stored in memory module 30. According to certain embodiments, if a particular database 70 is damaged, DBRC module 48 may use physical image copy 94 of that database 70 to recover that database 70. In other embodiments, DBRC module 48 may use flash image copy 92 rather than a physical image copy 94 for recovery of a database 70. Processor 42 may store flash image copy 92 and/or physical image copy 94 of database 70 in any suitable number and combination of memory modules 30.

Once flash image copy 92 and/or physical image copy 94 of database 70 is complete, database organizer module 170 may use flash image copy 92 and/or physical image copy 94 to reorganize the particular database 70 into shadow database 70′. Generating shadow database 70′ may comprise unloading data from flash image copy 92 and/or physical image copy 94 and organizing (reloading) that data into shadow database 70′. In generating shadow database 70′, database organizer module 170 may copy and/or reorganize the data in flash image copy 92 and/or physical image copy 94. Shadow database 70′ may be stored in any suitable number and combination of memory modules 30.

After shadow database 70′ is generated, processor 42 may determine whether database 70 is associated with one or more secondary indexes 76. If there are secondary indexes 76 associated with database 70, secondary index builder module 166 may rebuild secondary indexes 76 to be consistent with the reorganized shadow database 70′ generated by database organizer module 170. Secondary indexes 76 may be stored in any suitable number and combination of memory modules 30.

Call replay module 164 may then begin applying intercepted updates 14 to shadow database 70′. In particular, call replay module 164 may retrieve from call intercept memory 90 the intercepted updates 14 received from clients 20 and/or data sources 22 since the start of the reorganization of the particular database 70. Call replay module 164 may then replay or apply the intercepted updates 14 to shadow database 70′. Call replay module 164 is operable to determine an appropriate location in shadow database 70′ for each intercepted update 14. In particular, for an intercepted update 14 related to a particular data record 72, call replay module 164 is operable to identify in shadow database 70′ a space that corresponds to or is near to the particular data record 72. Call replay module 164 may apply the intercepted update 14 to that identified space. Call replay module 164 may notify processor 42 when all of the intercepted updates 14 have been transmitted to shadow database 70′. Processor 42 may then take the particular database 70 offline again.

Because replaying intercepted updates 14 to shadow database 70′ may not be instantaneous, it is possible for call intercept module 162 to intercept additional updates 14 during the call replay. Thus, to ensure that all intercepted updates 14 are applied to shadow database 70′, manager server 40 may repeat the call replay procedure. Accordingly, call replay module 164 may retrieve from call intercept module 162 any additional intercepted updates 14. Call replay module 164 may then replay the additional intercepted updates 14 to shadow database 70′. This second phase of replaying intercepted updates 14 to shadow database 70′ may ensure that all updates 14 received since the beginning of the reorganization process are applied to shadow database 70′. It should be understood that the call replay procedure may be repeated any number of times to ensure that all intercepted updates 14 are applied to shadow database 70′. Once the intercepted updates 14 are applied to shadow database 70′, processor 42 may register shadow database 70′ in manager memory 44. Registration of shadow database 70′ may comprise swapping the naming convention of the shadow database 70′ with that of the original database 70.

Once shadow database 70′ is registered, processor 42 may use memory module 30 to create flash image copy 92′ of shadow database 70′. Flash image copy 92′ of shadow database 70′ may be stored in memory module 30 and used for recovery of shadow database 70′ if the shadow database 70′ becomes damaged. After the creation of the flash image copy 92′ of shadow database 70′, processor 42 places shadow database 70′ online in place of the original database 70. Shadow database 70′ may then be used to respond to queries 12 submitted by clients 20. Because shadow database 70′ is a reorganized version of the original database 70, shadow database 70′ may enable database system 10 to operate more efficiently.

In some embodiments, once flash image copy 92′ of shadow database 70′ is complete, database image copier module 168 may use that flash image copy 92′ to generate physical image copy 94′ of shadow database 70′. Physical image copy 94′ of shadow database 70′ may be stored in memory module 30 for purposes of recovery. Should shadow database 70′ experience problems, physical image copy 94′ of shadow database 70′ may be used to recover from the problems. In some embodiments, database system 10 may be operable to use flash image copy 92′ for recovery purposes. The process of recovering a database 70 by means of flash image copy 92′ may be referred to as forward recovery. If a particular database system 10 is configured to conduct forward recovery of damaged databases 70, then it may not be necessary for database image copier module 168 to generate physical image copy 94′ of shadow database 70′.

Database system 10 has several important technical advantages. Various embodiments of the invention may have none, some, or all of these disadvantages. One advantage of the present invention is that it streamlines the process for reorganizing databases 70. According to traditional methods for online reorganization, systems are required to keep track of when each data record 72 is unloaded and when each update 14 is received. In traditional systems, the time when an update 14 was received must be compared with the time that the corresponding data record 72 was unloaded in order to determine whether the update 14 should be applied to the database 70 or discarded. In contrast, according to certain embodiments of the present invention, processor 42 is able to determine which updates 14 to apply to the database 70 without comparing the time when each update 14 is received with the time when the corresponding data records 72 are unloaded. Thus, the present invention conserves processing time and resources.

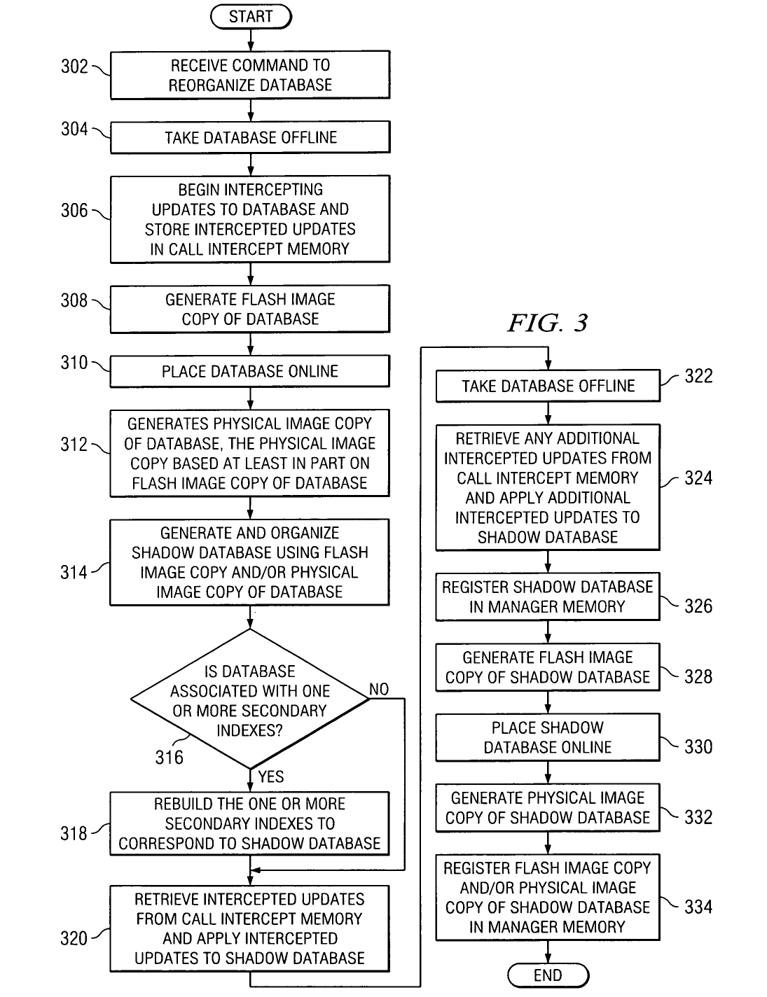

FIG. 3 illustrates a flowchart for online reorganization of a database 70 according to certain embodiments of the present invention. At step 302, processor 42 receives a command to reorganize a particular database 70. In some embodiments, the command may be received from an operator 80. In other embodiments, manager server 40 may be configured automatically initiate the reorganization of a particular database 70 based on one or more configurable conditions.

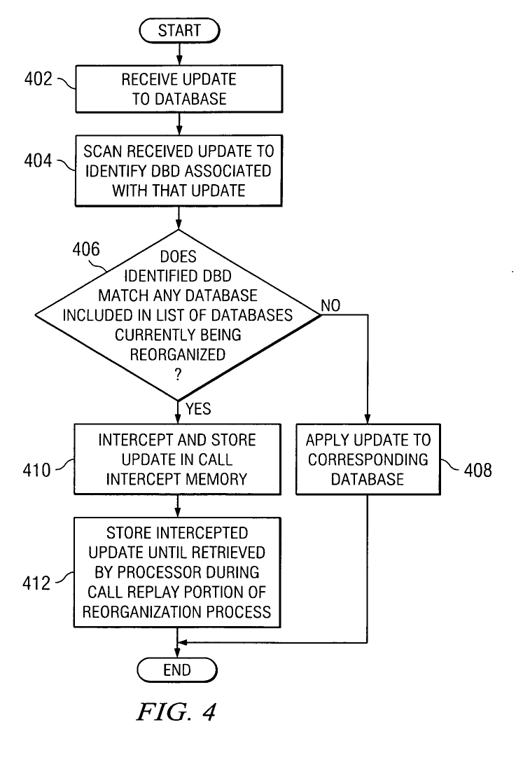

At step 304, processor 42 takes the particular database 70 offline. At step 306, processor 42 begins intercepting updates 14 to the particular database 70 from clients 20 and/or data sources 22. Processor 42 continues to intercept updates 14 to the particular database 70 throughout the reorganization process. Processor 42 stores the intercepted updates 14 in call intercept memory 90. The intercepting of updates 14 is described in further detail below with respect to FIG. 4.

At step 308, processor 42 uses memory module 30 to generate flash image copy 92 of the particular database 70. Processor 42 may store flash image copy 92 in any suitable number and combination of memory modules 30. At step 310, processor 42 places database 70 back online. Because the database 70 is placed back online, the database 70 may be usable for responding to queries 12 submitted by clients 20 during the reorganization of database 70.

At step 312, processor 42 generates physical image copy 94 of the particular database 70. Physical image copy 94 may be stored in memory module 30 and may be usable for recovery purposes in the event database 70 is damaged or destroyed. At step 314, processor 42 uses flash image copy 92 and/or physical image copy 94 to generate shadow database 70′. In generating shadow database 70′, processor 42 unloads data from flash image copy 92 and/or physical image copy 94 and organizes the data in shadow database 70′. Thus, shadow database 70′ is a more efficient version of the original database 70. Shadow database 70′ may be stored in any suitable number and combination of memory modules 30.

At step 316, processor 42 determines whether the particular database 70 is associated with one or more secondary indexes 76. If there are secondary indexes 76 associated with database 70, then at step 318 processor 42 rebuilds the secondary indexes 76 so that the secondary indexes 76 correspond to the data structure of shadow database 70′. If at step 316 processor 42 determines that the particular database 70 is not associated with one or more secondary indexes 76, then the method proceeds to step 320.

At step 320, processor 42 retrieves from call intercept memory 90 the intercepted updates 14 that correspond to the particular database 70. Processor 42 applies the intercepted updates 14 to shadow database 70′. Processor 42 is operable to determine an appropriate location in shadow database 70′ for each update 14. At step 322, processor 42 takes the particular database 70 offline again. At step 324, processor 42 retrieves and replays to shadow database 70′ any additional intercepted updates 14. This second phase of replaying intercepted updates 14 to shadow database 70′ may help ensure that all updates 14 received since the beginning of the reorganization process are applied to shadow database 70′. It will be understood that processor 42 may repeat the call replay process any number of times during the reorganization of database 70.

At step 326, processor 42 registers shadow database 70′ in manager memory 44. Registration of shadow database 70′ may comprise swapping the naming convention of shadow database 70′ with that of the original database 70. Registration may further comprise storing the name, status, and/or memory location of shadow database 70′ in manager memory 44. Thus, shadow database 70′ assumes the role of the original database 70.

At step 328, processor 42 uses memory module 30 to create a flash image copy 92′ of shadow database 70′. Flash image copy 92′ of shadow database 70′ may be stored in any number and combination of memory modules 30. According to certain embodiments, manager server 40 may use flash image copy 92′ of shadow database 70′ for recovery purposes should shadow database 70′ become damaged.

At step 330, processor 42 places shadow database 70′ online in place of the original database 70. Because shadow database 70′ is a reorganized version of the original database 70, database system 10 may use shadow database 70′ to more efficiently respond to queries 12 from clients 20. At step 332, processor 42 may create physical image copy 94′ of shadow database 70′. At step 334, physical image copy 94′ and/or flash image copy 92′ of shadow database 70′ may be registered in manager memory 44 for recovery purposes. Registration may comprise storing the name, status, and/or memory location of physical image copy 94′ and/or flash image copy 92′ of shadow database 70′ in manager memory 44. Should shadow database 70′ become damaged, manager server 40 may use physical image copy 94′ to recover shadow database 70′. In some embodiments, manager server 40 may be operable to use flash image copy 92′ of shadow database 70′ to recover shadow database 70′. In such embodiments, it may not be necessary to create physical image copy 94′ of shadow database 70′.

FIG. 4 illustrates a flowchart for intercepting updates 14 according to certain embodiments of the present invention. At step 402, processor 42 receives an update 14 for a particular database 70 stored in database system 10. At step 404, processor 42 scans the received update 14 to identify the DBD 144 associated with that update 14. At step 406, processor 42 determines whether the identified DBD 144 matches a database 70 included in list 142 of databases 70 currently being reorganized. List 142 of databases 70 currently being reorganized may be stored in manager memory 44 in manager server 40. If processor 42 determines that the identified DBD 144 does not match any database 70 currently being reorganized, then at step 408 the particular update 14 may be applied to the appropriate database 70 in memory module 30. If, however, processor 42 determines that the identified DBD 144 matches a database 70 currently being reorganized, then at step 410 processor 42 may intercept and store that update 14 in call intercept memory 90. At step 412, call intercept memory 90 may store the intercepted update 14 until processor 42 retrieves the intercepted update 14 during the call replay portion of the reorganization process.

By reorganizing database 70, database system 10 may be able to more quickly and accurately respond to queries 12 submitted by clients 20. By using flash image copy 92 of database 70 to reorganize database 70, database system 10 may reduce the amount of time that database 70 is offline during the reorganization process. By intercepting updates 14 to database 70 from clients 20 and/or data sources 22 during the reorganization process and by replaying the intercepted updates 14 to shadow database 70′, database system 10 may further reduce the amount of time that database 70 is offline during the reorganization process.

Although the present invention has been described in detail, it should be understood the various changes, substitutions, and alterations can be made hereto without departing from the scope of the invention as defined by the appended claims.

What is claimed is:

1. A method for reorganizing a database, comprising:
receiving at least one update to a first database;
generating a copy of the first database;
generating a shadow database wherein the shadow database:
represents a reorganized version of the first database; and
is based at least in part on the copy of the first database;
applying the at least one update to the shadow database; and
replacing the first database with the shadow database.

2. The method of claim 1, wherein the shadow database is generated while the first database is accessible to one or more clients of a database system.

3. The method of claim 1, wherein the at least one update is applied to the shadow database while the first database is accessible to one or more clients of a database system.

4. The method of claim 1, wherein:
the first database is associated with a first name; and
replacing the first database with the shadow database comprises assigning the first name to the shadow database.

5. The method of claim 1, wherein the copy represents a flash image copy of the first database.

6. The method of claim 5, further comprising generating a physical image copy of the first database, wherein:
the physical image copy is based at least in part on the flash image copy; and
the physical image copy is usable to recover and/or repair the first database.

7. The method of claim 1, wherein the copy represents a physical image copy of the first database.

8. The method of claim 7, further comprising generating a flash image copy of the first database, the physical image copy based at least in part on the flash image copy.

9. The method of claim 1, further comprising:
after receiving the at least one update to the first database, storing the at least one update in an intercept memory; and
after generating the shadow database, retrieving the at least one update from the intercept memory.

10. The method of claim 1, further comprising rebuilding a secondary index associated with the first database, the rebuilt secondary index corresponding to the shadow database.

11. The method of claim 1, further comprising generating a flash image copy of the shadow database, the flash image copy of the shadow database usable to recover and/or repair the shadow database.

12. The method of claim 1, further comprising generating a physical image copy of the shadow database, wherein:
the physical image copy of the shadow database is usable to recover and/or repair the shadow database; and
the physical image copy of the shadow database is generated while the shadow database is accessible to one or more clients of a database system.

13. The method of claim 1, further comprising:
after receiving the at least one update to the first database, identifying a database definition associated with the at least one update;
comparing the identified database definition with a database definition associated with a database currently being reorganized; and
if the identified database definition matches the database definition associated with the database currently being reorganized, storing the at least one update in an intercept memory.

14. Logic for reorganizing a database, the logic encoded in computer-readable media and operable when executed to:
receive at least one update to a first database;
generate a copy of the first database;
generate a shadow database wherein the shadow database:
represents a reorganized version of the first database; and
is based at least in part on the copy of the first database;
apply the at least one update to the shadow database; and
replace the first database with the shadow database.

15. The logic of claim 14, wherein the shadow database is generated while the first database is accessible to one or more clients of a database system.

16. The logic of claim 14, wherein the at least one update is applied to the shadow database while the first database is accessible to one or more clients of a database system.

17. The logic of claim 14, wherein:
the first database is associated with a first name; and
replacing the first database with the shadow database comprises assigning the first name to the shadow database.

18. The logic of claim 14, wherein the copy represents a flash image copy of the first database.

19. The logic of claim 18, wherein the logic is further operable when executed to generate a physical image copy of the first database, wherein:
the physical image copy is based at least in part on the flash image copy; and
the physical image copy is usable to recover and/or repair the first database.

20. The logic of claim 14, wherein the copy represents a physical image copy of the first database.

21. The logic of claim 20, wherein the logic is further operable when executed to generate a flash image copy of the first database, the physical image copy based at least in part on the flash image copy.

22. The logic of claim 14, wherein the logic is further operable when executed to:
after receiving the at least one update to the first database, store the at least one update in an intercept memory; and
after generating the shadow database, retrieve the at least one update from the intercept memory.

23. The logic of claim 14, wherein the logic is further operable when executed to rebuild a secondary index associated with the first database, the rebuilt secondary index corresponding to the shadow database.

24. The logic of claim 14, wherein the logic is further operable when executed to generate a flash image copy of the shadow database, the flash image copy of the shadow database usable to recover and/or repair the shadow database.

25. The logic of claim 14, wherein the logic is further operable when executed to generate a physical image copy of the shadow database, wherein:
the physical image copy of the shadow database is usable to recover and/or repair the shadow database; and
the physical image copy of the shadow database is generated while the shadow database is accessible to one or more clients of a database system.

26. The logic of claim 14, wherein the logic is further operable when executed to:
after receiving the at least one update to the first database, identify a database definition associated with the at least one update;
compare the identified database definition with a database definition associated with a database currently being reorganized; and
if the identified database definition matches the database definition associated with the database currently being reorganized, store the at least one update in an intercept memory.

27. A system for reorganizing a database, the system comprising:
a memory operable to store a first database;
a processor operable to:
receive at least one update to the first database;
generate a copy of the first database;
generate a shadow database wherein the shadow database:
represents a reorganized version of the first database; and
is based at least in part on the copy of the first database;
apply the at least one update to the shadow database; and
replace the first database with the shadow database.

28. The system of claim 27, wherein the shadow database is generated while the first database is accessible to one or more clients of a database system.

29. The system of claim 27, wherein the at least one update is applied to the shadow database while the first database is accessible to one or more clients of a database system.

30. The system of claim 27, wherein:
the first database is associated with a first name; and
replacing the first database with the shadow database comprises assigning the first name to the shadow database.

31. The system of claim 27, wherein the copy represents a flash image copy of the first database.

32. The system of claim 31, wherein the processor is further operable to generate a physical image copy of the first database, wherein:
the physical image copy is based at least in part on the flash image copy; and
the physical image copy is usable to recover and/or repair the first database.

33. The system of claim 27, wherein the copy represents a physical image copy of the first database.

34. The system of claim 33, wherein the processor is further operable to generate a flash image copy of the first database, the physical image copy based at least in part on the flash image copy.

35. The system of claim 27, wherein the processor is further operable to:
after receiving the at least one update to the first database, store the at least one update in an intercept memory; and
after generating the shadow database, retrieve the at least one update from the intercept memory.

36. The system of claim 27, wherein the processor is further operable to rebuild a secondary index associated with the first database, the rebuilt secondary index corresponding to the shadow database.

37. The system of claim 27, wherein the processor is further operable to generate a flash image copy of the shadow database, the flash image copy of the shadow database usable to recover and/or repair the shadow database.

38. The system of claim 27, wherein the processor is further operable to generate a physical image copy of the shadow database, wherein:
the physical image copy of the shadow database is usable to recover and/or repair the shadow database; and
the physical image copy of the shadow database is generated while the shadow database is accessible to one or more clients of a database system.

39. The system of claim 27, wherein the processor is further operable to:
after receiving the at least one update to the first database, identify a database definition associated with the at least one update;
compare the identified database definition with a database definition associated with a database currently being reorganized; and
if the identified database definition matches the database definition associated with the database currently being reorganized, store the at least one update in an intercept memory.
